(19) United States
(12) Patent Application Publication
(10) Pub. No.: US 2026/0141025 A1
(43) Pub. Date: May 21, 2026

(54) METHODS AND APPARATUS TO EXPLAIN A TREND IN MULTI-DIMENSIONAL TIME-SERIES DATA

(71) Applicant: DIRECTV, LLC, El Segundo, CA (US)

(72) Inventors: Taylor Philip Hosbach, Easton, PA (US); Johnson Hao-Wen Kuan, Gardena, CA (US); Malav Hiren Shah, Frisco, TX (US); Justin Nelson, Waxhaw, NC (US); Philip Nunoo, Richmond, VA (US); Kiran Narashim, Cypress, CA (US); Omer Solakli, Los Angeles, CA (US); Sumedh Godbole, Phoenix, AZ (US); Bryant Clark, Leander, TX (US)

(21) Appl. No.: 18/949,696

(22) Filed: Nov. 15, 2024

(51) Int. Cl. G06F 17/18

(52) U.S. Cl. CPC G06F 17/18

(57) ABSTRACT

Systems, apparatus, articles of manufacture, and methods to explain a trend in multi-dimensional time-series data are disclosed. An example method includes detecting a trend in multi-variate time-series data, providing data associated with the detected trend to a first machine learning model to cause summarization of the detected trend, and providing the summarization of the detected trend to a second machine learning model to cause preparation of an explanation of the summarization, the explanation of the summarization based on one or more documents made available to the second machine learning model.

### FIELD OF THE DISCLOSURE

This disclosure relates generally to trend detection and, more particularly, to methods and apparatus to explain a trend in multi-dimensional time-series data.

### BACKGROUND

The field of artificial intelligence (AI) has seen significant advancements in recent years, with applications spanning various industries and domains. AI systems have been developed to perform tasks that typically require human-level intelligence, such as learning from data, recognizing patterns, making decisions, and generating insights. As organizations continue to generate vast amounts of data, the need for effective methods to analyze, interpret, and utilize this information has become increasingly important.

### BRIEF DESCRIPTION OF THE DRAWINGS

FIG. 1 illustrates an example environment in which a trend explanation system is used to explain trends in multi-dimensional time-series data.

FIG. 2 is a flowchart representative of example machine readable instructions and/or example operations that may be executed, instantiated, and/or performed by example programmable circuitry to implement the trend explanation system of FIG. 1.

FIG. 3 is a flowchart representative of example machine readable instructions and/or example operations that may be executed, instantiated, and/or performed by example programmable circuitry to implement the trend explanation system of FIG. 1.

FIG. 4 is a block diagram illustrating an example arrangement of attributes.

FIG. 5 is a block diagram illustrating an example prompt requesting trend summarization, and an example output of such a trend summarization.

FIG. 6 is a block diagram of an example processing platform including programmable circuitry structured to execute, instantiate, and/or perform the example machine readable instructions and/or perform the example operations of FIGS. 2 and/or 3 to implement the trend explanation system of FIG. 1.

FIG. 7 is a block diagram of an example implementation of the programmable circuitry of FIG. 6.

FIG. 8 is a block diagram of another example implementation of the programmable circuitry of FIG. 6.

FIG. 9 is a block diagram of an example software/firmware/instructions distribution platform (e.g., one or more servers) to distribute software, instructions, and/or firmware (e.g., corresponding to the example machine readable instructions of FIGS. 2 and/or 3) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

The ability to extract valuable insights from complex datasets is critical in today's fast-paced business environment, where speed, accuracy, and decision-making are essential components of success.

In recent years, there has been a growing recognition of the importance of integrating AI with other technologies, such as data analytics, machine learning, and natural language processing. This integration enables organizations to leverage the strengths of each technology domain, creating powerful tools for solving complex problems and driving innovation.

The development of sophisticated AI systems that can learn from large datasets, recognize patterns, and generate insights has significant implications across various industries, including business, healthcare, finance, and more. As such, there is a growing need for innovative approaches to developing AI systems that can effectively analyze and interpret complex data sets, providing valuable insights that inform decision-making. Examples disclosed herein present a multi-stage approach that includes detection of one or more trends in multi-variate time-series data, use of one or more machine learning models for summarization of those detected trend(s), and then use of one or more machine learning models for contextualization of the summarization of the detected trend(s).

Examples disclosed herein utilize artificial intelligence for generation of explanations of trends detected in data. Artificial intelligence (AI), including machine learning (ML), deep learning (DL), Large Language Models (LLMs) and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, a Large Language Model (LLM) is used. Using an LLM enables detailed trend summarizations as well as contextualizations/explanations to be created. In general, machine learning models/architectures that are suitable to use in the example approaches disclosed herein will be transformer-type models, that receive one or more inputs (e.g., a prompt), and generate a corresponding output (e.g., a summary or contextualization of data provided in and/or associated with the prompt). However, other types of machine learning models could additionally or alternatively be used.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

Beyond initial training of a model, further training, sometimes referred to as fine-tuning may be performed. Fine-tuning involves taking an existing, pre-trained model, and further training the model on a smaller, task-specific dataset. An example goal of this process is to make the model adapt to the nuances and requirements of the target task while retaining the valuable knowledge and representations the model has acquired during the initial pre-trained training phase.

In other words, the pre-trained model typically serves as a starting point, providing a foundation of generalized knowledge that spans across various domains. For instance, in natural language processing, pre-trained language models (e.g., GPT-3, GPT-4) have already learned grammar, syntax, and world knowledge from extensive text corpora. Fine-tuning such pre-trained models builds upon this foundation by adjusting the model's weights and parameters based on the new, task-specific data.

To accomplish fine-tuning, a dataset that is specific to the task to be performed is used. This dataset contains examples or samples relevant to the task, often with associated labels or annotations. Thus, examples disclosed herein may utilize a model that has been fine-tuned using prior explanations, summarizations, and/or contextualizations of trend data. During fine-tuning, the model is trained to recognize patterns and features in the task-specific data, aligning the internal representations within the model to the requirements of the target task.

Fine-tuning may involve not only updating the model's weights but also adjusting hyperparameters like learning rates, batch sizes, and regularization techniques to ensure that the model converges effectively on the new task. Depending on the complexity of the task, architectural changes may also be made to the model, such as freezing certain layers, adding task-specific layers, or modifying the model structure. Fine-tuning is a powerful technique used in various domains, including natural language processing, computer vision, recommendation systems, and more, as it enables the adaptation of pre-trained models to solve specific real-world problems efficiently and effectively.

Once training is complete, the model is deployed for use as an executable construct that processes an input and provides an output. Such execution of the model is often referred to as an inference phase. In the inference phase, data to be analyzed (e.g., live data) is input to the model, and the model executes to create an output. This inference phase can be thought of as the AI “thinking” to generate the output based on what was learned from the training and/or fine-tuning (e.g., by executing the model to apply the learned patterns and/or associations to the live data). In some examples, input data undergoes pre-processing before being used as an input to the machine learning model. Moreover, in some examples, the output data may undergo post-processing after it is generated by the model to transform the output into a useful result (e.g., a display of data, an instruction to be executed by a machine, etc.).

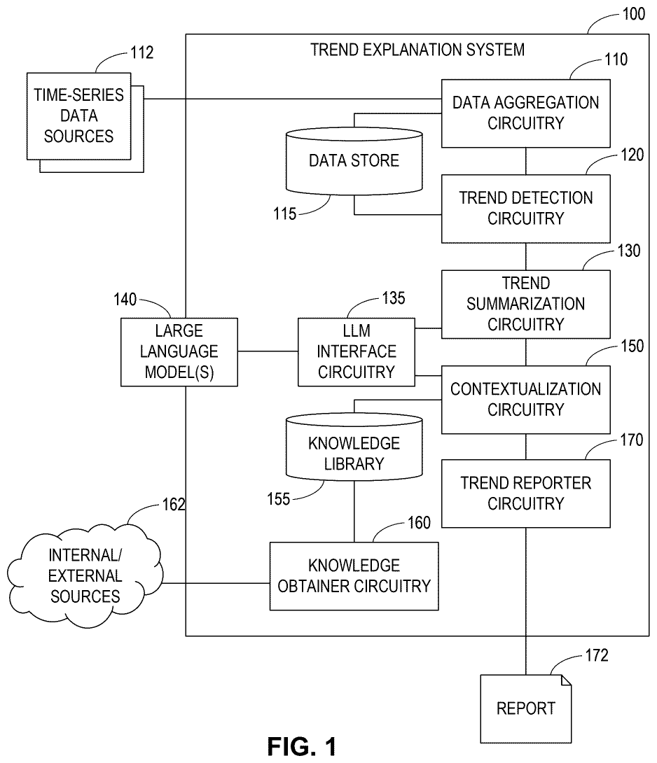

FIG. 1 illustrates an example environment in which a trend explanation system 100 is used to explain trends in multi-dimensional time-series data. In examples disclosed herein, the data is multi-dimensional (sometimes referred to as multi-variate, or multi-attribute) in that multiple attributes might be represented over a time series. For example, sales data might include (within a particular time range) values for sales of various products (e.g., a first dimension/variable/attribute), for different sales channels (a second dimension/variable/attribute), and across different markets (a third dimension/variable/attribute). When many dimensions are used (e.g., hundreds of dimensions), detection of trends across various combinations of dimensions quickly becomes unfeasible for a human to complete. The example trend explanation system 100 of FIG. 1 includes data aggregation circuitry 110, a data store 115, trend detection circuitry 120, Large Language Model (LLM) interface circuitry 135, contextualization circuitry 150 knowledge obtainer circuitry 160, a knowledge library 155, and trend reporter circuitry 170. The trend explanation system may interface with one or more time-series data sources 112, one or more LLMs 140, and internal/external data sources 162.

The trend explanation system aggregates 100 data from various sources 112, such as sales data or ticketing data, using the data aggregation circuitry 110. This aggregated data is then stored in the data store 115, where the aggregated data can be analyzed for trends using the trend detection circuitry 120. Once a trend has been detected, the trend summarization circuitry 130 prepares a prompt to summarize that trend. The Large Language Model (LLM) interface circuitry 135 interfaces with one or more Large Language Models (LLMs) (140) to provide the prompt to the LLM 140. The LLM(s) then generate a response based on this prompt, which is accessed by the LLM interface circuitry 135. To provide additional context for these summaries, the contextualization circuitry 150 also retrieves relevant information from internal/external sources using the knowledge obtainer circuitry (160), which is stored in the knowledge library (155), and provides a prompt to the LLM 140 to solicit an explanation of the summarized trend that is contextualized against the internal/external sources. Finally, the trend reporter circuitry 170 generates a report 172 that summarizes and contextualizes the detected trends, providing insights to users.

The example time series data sources 112 of the illustrated example of FIG. 1 represent various types of time-series data that are used as inputs to the trend-explanation system 100. These sources can include, but are not limited to, sales data, ticketing data, customer behavior patterns, and other forms of temporal data that provide insights into trends, errors, issues, performance, etc. The Time-Series Data Sources 112 may be sourced from various internal or external systems, such as databases, customer relationship management (CRM) platforms, enterprise resource planning (ERP) systems, Internet of Things (IoT) devices, etc. These sources can provide a wide range of data types, including numerical values, categorical labels, text-based information, images, etc. By aggregating and analyzing these time-series data sources, the trend explanation system 100 is able to identify patterns, trends, and correlations that would be difficult or impossible for humans to detect on their own.

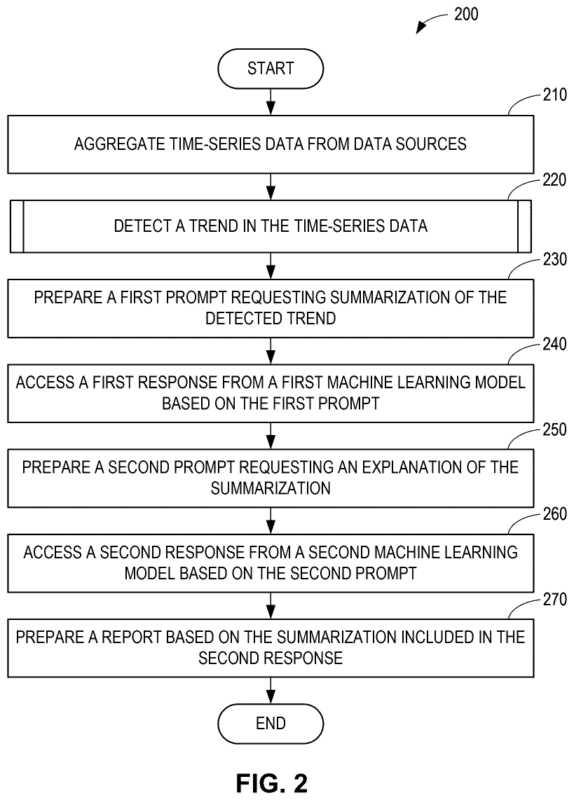

The example data aggregation circuitry 110 of the illustrated example of FIG. 1 aggregates time-series data from the various sources 112 for storage in the data store 115. In some examples, the data may be retrieved by querying an application programming interface (API) of the data source, or via other data collection techniques. The example data aggregation circuitry 110 consolidates accessed data (e.g., incoming data streams) into a common format, allowing for consistent storage and/or retrieval of the accessed data in the example data store 115 for later use by the trend detection circuitry 120. In some examples, the data aggregation circuitry 110 is instantiated by programmable circuitry executing data aggregation instructions and/or configured to perform operations such as those represented by the flowchart(s) of FIG. 2.

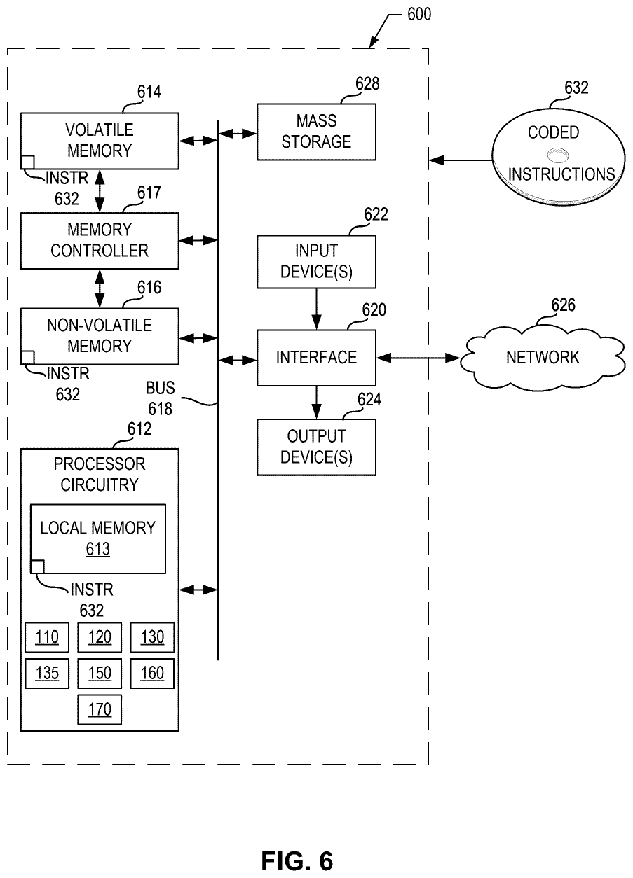

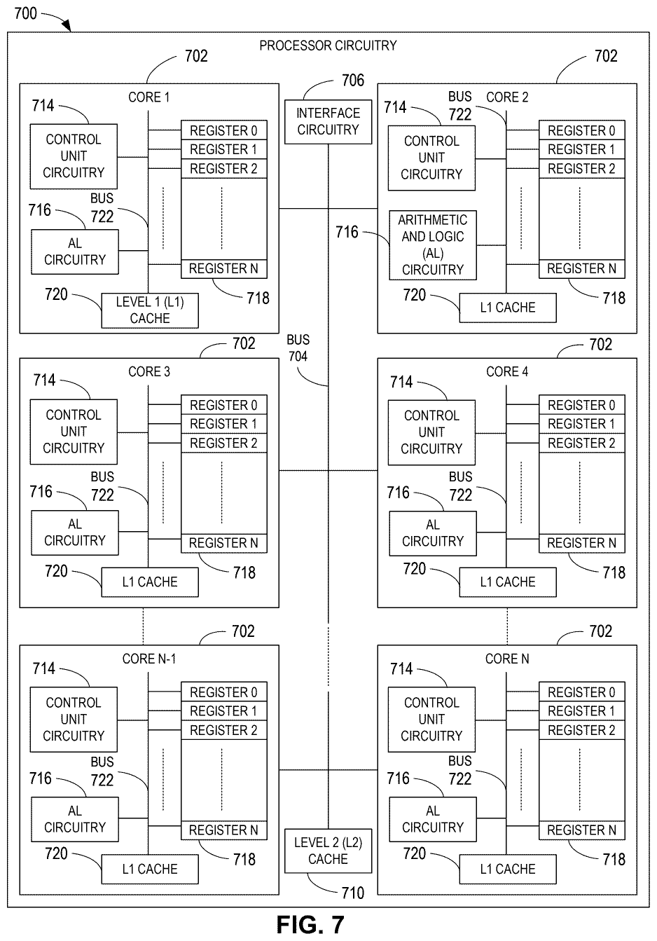

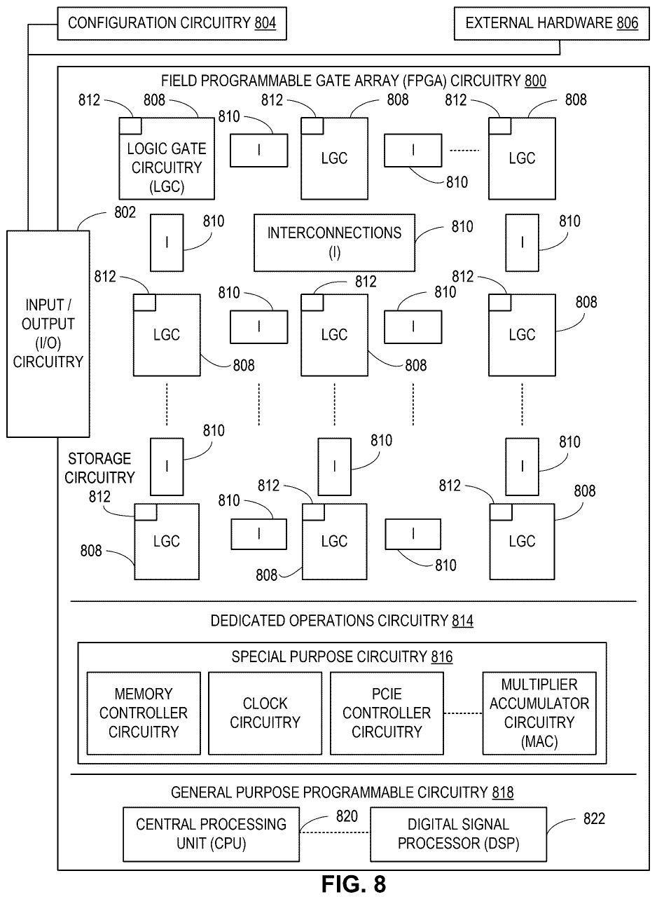

In some examples, the trend explanation system 100 includes means for aggregating data For example, the means for aggregating data may be implemented by the example data aggregation circuitry 110. In some examples, the example data aggregation circuitry 110 may be instantiated by programmable circuitry such as the example programmable circuitry 612 of FIG. 6. For instance, the data aggregation circuitry 110 may be instantiated by the example microprocessor 700 of FIG. 7 executing machine executable instructions such as those implemented by at least block 210 of FIG. 2. In some examples, the data aggregation circuitry 110 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the data aggregation circuitry 110 may be instantiated by any other combination of hardware, software, and/or firmware. For example, the data aggregation circuitry 110 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example data store 115 of the illustrated example of FIG. 1 serves as a centralized repository for storing data aggregated or obtained by the data aggregation circuitry 110. The example data store 115 of the illustrated example of FIG. 1 is implemented by any memory, storage device and/or storage disc for storing data such as, for example, flash memory, magnetic media, optical media, solid state memory, hard drive(s), thumb drive(s), etc. Furthermore, the data stored in the example data store 115 may be in any data format such as, for example, binary data, comma delimited data, tab delimited data, structured query language (SQL) structures, etc. While, in the illustrated example, the data store 115 is illustrated as a single device, the example data store 115 and/or any other data storage devices described herein may be implemented by any number and/or type(s) of memories. In the illustrated example of FIG. 1, the example data store 115 stores data collected by the example data aggregation circuitry 110. The data store 115 enables efficient management and retrieval of large volumes of data, allowing for quick access to insights and trends extracted from various sources.

The trend detection circuitry 120 of FIG. 1 analyzes the time-series data stored in the data store 115 to prepare trend detection statistics. The example trend detection circuitry 120 examines the aggregated data to identify patterns and/or trends, generating statistical information that can be used for further analysis or decision-making by the trend summarization circuitry 130. In examples disclosed herein, data having various combinations of attributes are segmented and analyzed to detect such trends. In some examples, the trend detection circuitry 120 is instantiated by programmable circuitry executing trend detection instructions and/or configured to perform operations such as those represented by the flowchart(s) of FIGS. 2 and/or 3.

In some examples, the trend explanation system 100 includes means for detecting a trend. For example, the means for detecting a trend may be implemented by trend detection circuitry 120. In some examples, the trend detection circuitry 120 may be instantiated by programmable circuitry such as the example programmable circuitry 612 of FIG. 6. For instance, the trend detection circuitry 120 may be instantiated by the example microprocessor 700 of FIG. 7 executing machine executable instructions such as those implemented by at least blocks 220, 305, 310, 320, 330, 340, 350, 360, 370, 375 of FIGS. 2 and/or 3. In some examples, the trend detection circuitry 120 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the trend detection circuitry 120 may be instantiated by any other combination of hardware, software, and/or firmware. For example, the trend detection circuitry 120 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example trend summarization circuitry 130 of the illustrated example of FIG. 1 prepares a prompt to be used by the LLM interface circuitry 135 and/or the LLM 140, which is then utilized to cause generation of a summarization of the trend detected by the trend detection circuitry 120. The trend summarization circuitry 130 takes the statistical information generated by the trend detection circuitry 120 and transforms it into a prompt that is used processed by the LLM 140 for generation of a concise and meaningful summary that can be used for further analysis or decision-making. In some examples, the trend summarization circuitry 130 is instantiated by programmable circuitry executing trend summarization instructions and/or configured to perform operations such as those represented by the flowchart(s) of FIG. 2.

In some examples, the trend explanation system 100 includes means for determining summarizing a trend. For example, the means for summarizing may be implemented by trend summarization circuitry 130. In some examples, the trend summarization circuitry 130 may be instantiated by programmable circuitry such as the example programmable circuitry 612 of FIG. 6. For instance, the trend summarization circuitry 130 may be instantiated by the example microprocessor 700 of FIG. 7 executing machine executable instructions such as those implemented by at least block 230 of FIG. 2. In some examples, the trend summarization circuitry 130 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the trend summarization circuitry 130 may be instantiated by any other combination of hardware, software, and/or firmware. For example, the trend summarization circuitry 130 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example LLM interface circuitry 135 of the illustrated example of FIG. 1 enables communication between the trend explanation system 100 and one or more LLMs 140. In the illustrated example of FIG. 1, the LLM 140 is shown as being at the edge of the trend explanation system 100 to illustrate that the LLM 140 might be implemented locally to the trend explanation system 100. As a result, the example LLM interface circuitry 135 might be implemented differently depending on whether the LLM 140 is implemented locally or remotely from the trend explanation system 100. The LLM interface circuitry 135 receives prompts to be executed from the trend summarization circuitry 130 and/or the contextualization circuitry 150. The LLM interface circuitry 135 then forwards these prompts to the designated LLM(s), and receives a response message that is relayed back to the trend summarization circuitry 130 and/or the contextualization circuitry 150. In some examples, the LLM interface circuitry 135 is instantiated by programmable circuitry executing LLM interface instructions and/or configured to perform operations such as those represented by the flowchart(s) of FIG. 2.

In some examples, the trend explanation system 100 includes means for interfacing with an LLM. For example, the means for interfacing with an LLM may be implemented by LLM interface circuitry 135. In some examples, the LLM interface circuitry 135 may be instantiated by programmable circuitry such as the example programmable circuitry 612 of FIG. 6. For instance, the LLM interface circuitry 135 may be instantiated by the example microprocessor 700 of FIG. 7 executing machine executable instructions such as those implemented by at least blocks 240, 260 of FIG. 2. In some examples, the LLM interface circuitry 135 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the LLM interface circuitry 135 may be instantiated by any other combination of hardware, software, and/or firmware. For example, the LLM interface circuitry 135 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 1, the LLM(S) 140 is illustrated at the edge of the customer messaging platform trend explanation system 100 to represent that the large language model(s) 140 may be executed/implemented either locally to the trend explanation system 100 or at a computing system remote from the trend explanation system 100. For example, large language models may be executed in a cloud setting (e.g., remotely from the trend explanation system 100). Remote execution offers some advantages including, for example, that the LLM can be accessed from anywhere, providing scalability and ease of use. Cloud-based models are usually more powerful than locally-executed models, as cloud-based models typically leverage high-performance hardware and are continuously updated with the latest improvements and fine-tuning. However, cloud-based models may raise concerns about data privacy, latency, and cost, as entities typically pay for the computational resources they consume (e.g., entities pay for use of the cloud-based model).

On the other hand, executing large language models locally provides an entity with more control over their data, and potentially lower latency for inference. Local execution can also work offline, which is beneficial in scenarios with limited Internet access or where data privacy is important. However, local execution typically requires powerful hardware, significant storage, and regular updates to maintain model performance. In some examples, the LLMs 140 may be implemented using LLM circuitry and/or other hardware specific to execution of large language models.

In some examples, the trend explanation system 100 includes means for inferring. For example, the means for inferring may be implemented by one or more LLMs 140. In some examples, the one or more LLMs 140 may be instantiated by programmable circuitry such as the example programmable circuitry 612 of FIG. 6. For instance, the one or more LLMs 140 may be instantiated by the example microprocessor 700 of FIG. 7 executing machine executable instructions. In some examples, the one or more LLMs 140 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the one or more LLMs 140 may be instantiated by any other combination of hardware, software, and/or firmware. For example, the one or more LLMs 140 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example contextualization circuitry 150 of the illustrated example of FIG. 1 generates prompts that enable the Large Language Model (LLM) 140 to produce explanations of summarized trends based on additional contextual information stored in the knowledge library 155. In this manner, the knowledge library 155 may be accessed by the LLM 140 using retrieval augmented generation (RAG) techniques. This allows the LLM 140 to take into account various factors, such as historical data, industry insights, and expert opinions, to create a prompt that is tailored to elicit an explanation from the LLM that provides valuable context for understanding the trend being analyzed. By leveraging this contextualization circuitry, the system can generate explanations that are not only informative but also relevant and actionable, allowing users to make more informed decisions based on the analysis of trends. In some examples, the contextualization circuitry 150 is instantiated by programmable circuitry executing contextualization instructions and/or configured to perform operations such as those represented by the flowchart(s) of FIG. 2.

In some examples, the trend explanation system 100 includes means for contextualizing. For example, the means for contextualizing may be implemented by contextualization circuitry 150. In some examples, the contextualization circuitry 150 may be instantiated by programmable circuitry such as the example programmable circuitry 612 of FIG. 6. For instance, the contextualization circuitry 150 may be instantiated by the example microprocessor 700 of FIG. 7 executing machine executable instructions such as those implemented by at least block 250 of FIG. 2. In some examples, the contextualization circuitry 150 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the contextualization circuitry 150 may be instantiated by any other combination of hardware, software, and/or firmware. For example, the contextualization circuitry 150 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example knowledge library 155 of the illustrated example of FIG. 1 is a centralized repository for storing and organizing valuable insights, data points, and domain-specific information that can be leveraged to contextualize summarized trends. This comprehensive resource enables the LLM 140 to quickly access relevant knowledge, such as industry reports, market research studies, customer feedback, or internal business intelligence, which can inform the contextualization of the summarized trends. In examples disclosed herein, the knowledge library 155 is accessed by the LLM 140 using retrieval augmented generation (RAG). However, any other approach to providing information from the knowledge library 155 to the LLM 140 may additionally or alternatively be used. In some examples, the information stored in the knowledge library 155 may be curated by a user and/or administrator. In some examples, the information stored in the knowledge library 155 represents internal information relevant to the products, regions, sales channels, etc. for which trends are to be analyzed.

The example knowledge library 155 of the illustrated example of FIG. 1 is implemented by any memory, storage device and/or storage disc for storing data such as, for example, flash memory, magnetic media, optical media, solid state memory, hard drive(s), thumb drive(s), etc. Furthermore, the data stored in the example knowledge library 155 may be in any data format such as, for example, binary data, comma delimited data, tab delimited data, structured query language (SQL) structures, etc. While, in the illustrated example, the knowledge library 155 is illustrated as a single device, the example knowledge library 155 and/or any other data storage devices described herein may be implemented by any number and/or type(s) of memories.

The knowledge obtainer circuitry 160 of the illustrated example of FIG. 1 retrieves relevant data from the internal and external sources 162. In this manner, the example knowledge obtainer circuitry 160 enables integration with various knowledge repositories, including databases, file systems, and cloud storage services that might provide information that might help provide a context for summarized trends. In examples disclosed herein, the knowledge obtainer circuitry 160 periodically and/or a-periodically executes to retrieve information from the internal and/or external sources 162. In some examples, the knowledge obtainer circuitry 160 is instantiated by programmable circuitry executing knowledge obtaining instructions.

In some examples, the trend explanation system 100 includes means for obtaining knowledge. For example, the means for obtaining knowledge may be implemented by the example knowledge obtainer circuitry 160. In some examples, the knowledge obtainer circuitry 160 may be instantiated by programmable circuitry such as the example programmable circuitry 612 of FIG. 6. For instance, the knowledge obtainer circuitry 160 may be instantiated by the example microprocessor 700 of FIG. 7 executing machine executable. In some examples, the knowledge obtainer circuitry 160 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the knowledge obtainer circuitry 160 may be instantiated by any other combination of hardware, software, and/or firmware. For example, the knowledge obtainer circuitry 160 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example internal/external sources 162 of the illustrated example of FIG. 1 provide contextual information that can be used to summarize trends. These sources may include both public and private datasets, such as sports schedules from specific markets, which could help explain an increase in viewership within those regions. Additionally, these sources might also comprise internal company data, like sales figures or customer demographics, which can offer valuable insights into market dynamics and consumer behavior. By incorporating this diverse range of information, the trend explanation system can provide a more comprehensive understanding of trends and their underlying drivers, enabling businesses to make informed decisions and stay ahead in an ever-changing marketplace.

The example trend reporter circuitry 170 of the illustrated example of FIG. 1 generates a comprehensive report that summarizes and contextualizes trends detected in time-series data. The example trend reporter circuitry 170 takes as input the summarization of the detected trend generated by the first machine learning model and uses this information to prepare an explanation of the trend's underlying drivers/causes/rationales. The trend reporter circuitry 170 achieves this by parsing information retrieved by the contextualization circuitry 150. The trend reporter circuitry 170 generates a report that not only highlights the presence of a trend but also sheds light on its underlying causes and implications for business decision-making. In some examples, the trend reporter circuitry 170 is instantiated by programmable circuitry executing trend reporting instructions and/or configured to perform operations such as those represented by the flowchart(s) of FIG. 2.

In some examples, the trend explanation system 100 includes means for preparing a report. For example, the means for preparing a report may be implemented by trend reporter circuitry 170. In some examples, the trend reporter circuitry 170 may be instantiated by programmable circuitry such as the example programmable circuitry 612 of FIG. 6. For instance, the trend reporter circuitry 170 may be instantiated by the example microprocessor 700 of FIG. 7 executing machine executable instructions. In some examples, the trend reporter circuitry 170 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the trend reporter circuitry 170 may be instantiated by any other combination of hardware, software, and/or firmware. For example, the trend reporter circuitry 170 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example report 172 of the illustrated example of FIG. 1 is generated by the trend explanation system 100 and provides a summary and analysis of detected trends in accessed time-series data, including contextualization thereof. The example report 172 may be formatted in various ways, such as Portable Document Format (PDF), Microsoft™ Excel, or web-based presentation, allowing for easy dissemination to stakeholders. The report presents key findings, including the identified trends, their significance, and insights into underlying drivers that contributed to these patterns. Additionally, report 172 may include visualizations, charts, and graphs to facilitate understanding of complex data relationships and trends, making the report 172 useful for business decision-making and strategic planning.

While an example manner of implementing the trend explanation system 100 is illustrated in FIG. 1, one or more of the elements, processes, and/or devices illustrated in FIG. 1 may be combined, divided, re-arranged, omitted, eliminated, and/or implemented in any other way. Further, the example data aggregation circuitry 110, the example trend detection circuitry 120, the example trend summarization circuitry 130, the example LLM interface circuitry 135, the example contextualization circuitry 150, the example knowledge obtainer circuitry 160, the example trend reporter circuitry 170, and/or, more generally, the example trend explanation system 100 of FIG. 1, may be implemented by hardware alone or by hardware in combination with software and/or firmware. Thus, for example, any of the example data aggregation circuitry 110, the example trend detection circuitry 120, the example trend summarization circuitry 130, the example LLM interface circuitry 135, the example contextualization circuitry 150, the example knowledge obtainer circuitry 160, the example trend reporter circuitry 170, and/or, more generally, the example trend explanation system 100, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example trend explanation system 100 of FIG. 1 may include one or more elements, processes, and/or devices in addition to, or instead of, those illustrated in FIG. 1, and/or may include more than one of any or all of the illustrated elements, processes and devices.

Flowchart(s) representative of example machine readable instructions, which may be executed by programmable circuitry to implement and/or instantiate the trend explanation system 100 of FIG. 1 and/or representative of example operations which may be performed by programmable circuitry to implement and/or instantiate the trend explanation system 100 of FIG. 1, are shown in FIGS. 2 and/or 3. The machine readable instructions may be one or more executable programs or portion(s) of one or more executable programs for execution by programmable circuitry such as the programmable circuitry 612 shown in the example processor platform 600 discussed below in connection with FIG. 6 and/or may be one or more function(s) or portion(s) of functions to be performed by the example programmable circuitry (e.g., an FPGA) discussed below in connection with FIGS. 7 and/or 8. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 2 and/or 3, many other methods of implementing the example trend explanation system 100 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 2 and/or 3 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 2 is a flowchart representative of example machine readable instructions and/or example operations 200 that may be executed, instantiated, and/or performed by programmable circuitry to detect and summarize a trend in data. The example machine-readable instructions and/or the example operations 200 of FIG. 2 begin at block 210, where the data aggregation circuitry 110 aggregates time series data from various data sources 112. (Block 210). The data aggregation circuitry 110 collects and combines large amounts of data from disparate locations, such as databases, files, networks, etc. into a single repository. Aggregating the data enables the identification of trends, patterns, correlations, etc. among the separate data sources. This in turn enables the detection of meaningful insights and relationships that may not be apparent when examining individual datasets in isolation.

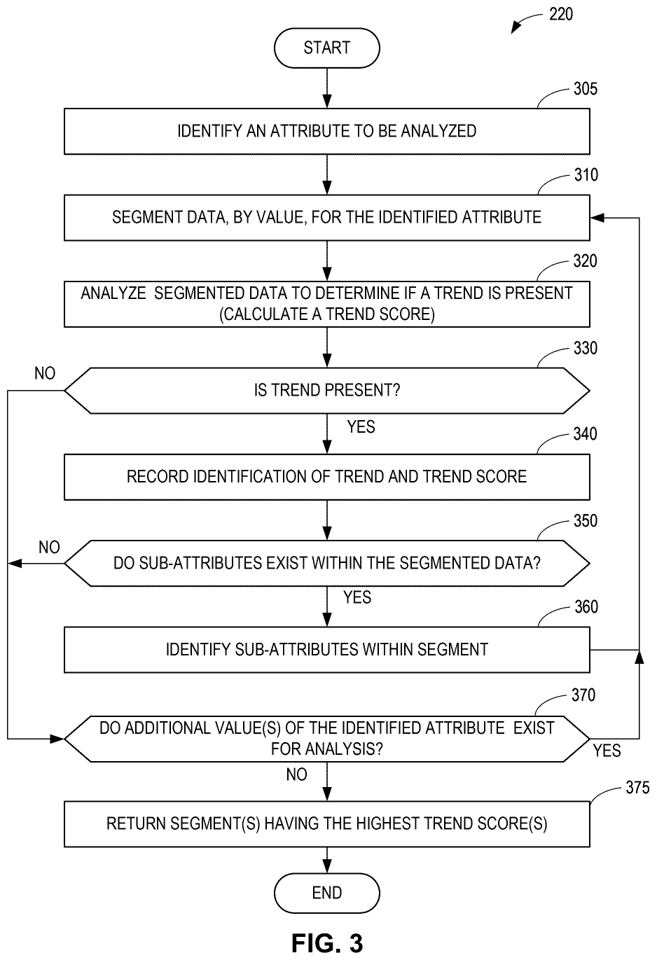

The example trend detection circuitry 120 detects a trend in the time-series data aggregated by data aggregation circuitry 110. (Block 220). This operation involves analyzing the processed data to identify patterns and relationships that indicate a meaningful change or direction over time. An example approach to partitioning the data for detection of a trend is disclosed below in connection with FIG. 3. In addition, the trend detection process may employ various techniques, such as statistical analysis, machine learning algorithms, or rule-based decisions, to determine whether the observed changes are significant.

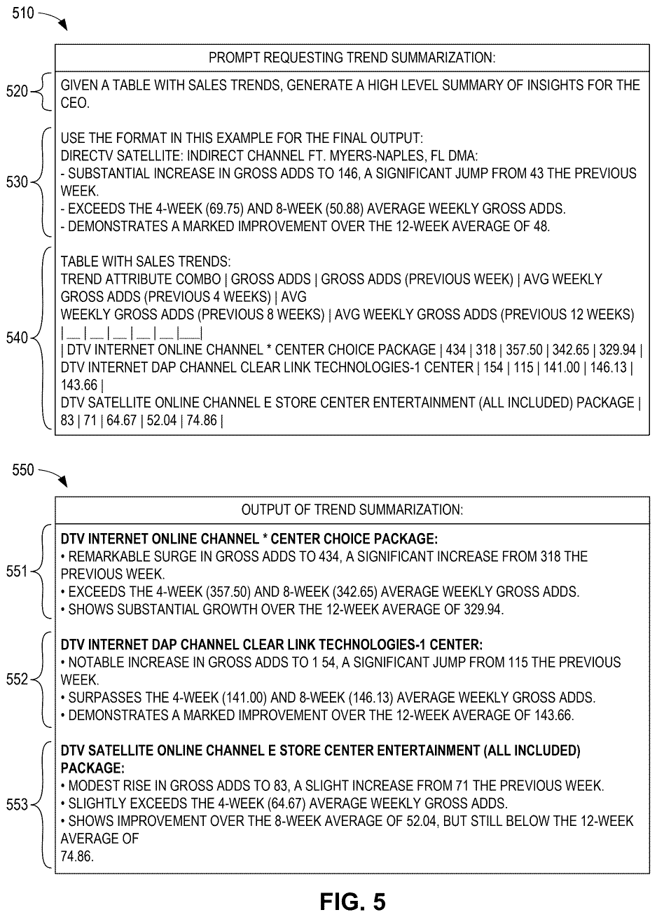

The example trend summarization circuitry 130 prepares a first prompt requesting summarization of a trend detected by the trend detection circuitry 120. (Block 230). This operation involves generating a request that can be used to solicit a summary from the LLM(s) 140. The prompt may include relevant information about the detected trend, such as its characteristics, magnitude, and significance, to provide context for the summarization process. In some examples, the prompt is created based on a prompt template that includes standardized instructions that are used to direct the generation of an output by the LLM 140. An example prompt is disclosed below in connection with FIG. 5.

The example LLM interface circuitry 130 interacts with the LLM 140 to provide the first prompt created by the trend summarization circuitry 130 to the LLM 140. (Block 240). In some examples, the first prompt is provided to the LLM 140 by the LLM interface circuitry 130 via a web request communicated via a network, such as the Internet. However, any other approach to communicating a prompt to the LLM 140 may additionally or alternatively be used. The LLM 140 uses the first prompt to generate a first response message, which is then included in a reply to the LLM interface circuitry 130. In some examples, the first prompt provided to the LLM 140 identifies additional parameters that are to be used when generating the first response including, for example, an identifier of a model to be used, context information and/or embeddings, etc. The example LLM interface circuitry 130 accesses the first response message from the LLM 140. This first response may include a summary of the detected trend, along with any relevant analysis or insights provided by the LLM 140.

The example contextualization circuitry 150 then prepares a second prompt requesting an explanation of the summarization included in the first response message. (Block 250). The second prompt is created using a prompt template (which may be different from the prompt template used to create the first prompt). In some examples, information present in the knowledge library is made accessible to the LLM 140 using techniques such as Retrieval Augmented Generation (RAG). The second prompt is designed to elicit an explanation from the LLM 140, thereby providing additional context and insights into the summarization of the trend generated earlier. In some examples, the second prompt requests that the response include citations and/or other references to any information used from the knowledge library 155. The example LLM interface circuitry 135 provides the second prompt to the LLM 140, and subsequently accesses a second response from a LLM 140 based on the second prompt. (Block 260). The response is provided to the contexualization circuitry 150, which may then store the contextualization provided by the second response in association with the detected trend. The second response provides additional context and insights into the detected trend, allowing users to better understand the underlying factors driving the trend and make more informed decisions. As noted above, the second prompt may request that the LLM 140 provide citations and/or other references to any information used from the knowledge library 155. In this manner, a user reviewing the contextualization information may validate and/or better understand the explanation of the trend. For example, increased sports viewership in a particular market might result from the local sports teams within that market having a winning record. Likewise, decreased sports viewership might result from the completion of a sports season for a team within the particular market. Such explanation(s) included in the second response might reference the schedule of those teams within the market (e.g., may include a reference to a document in the knowledge library 155).

The example report generation circuitry 170 prepares a report 172 based on the summarization included in the second response and/or the summarization of the trend included in the first response. (Block 270). The report 172 may be formatted and/or provided in any manner including, for example, as an email message, in a portable document format (PDF) file, as a web page, as a response to a web request, etc. The report 172 provides a concise and actionable summary of the findings, allowing users to quickly understand the underlying factors driving the trend and make informed decisions.

The example process 200 of FIG. 2 then terminates, but may repeated again at a later time. In some examples, the process 200 of FIG. 2 may be run on a periodic basis (e.g., daily, weekly, monthly, etc.) to enable detection of new trends and provide reports summarizing those trends.

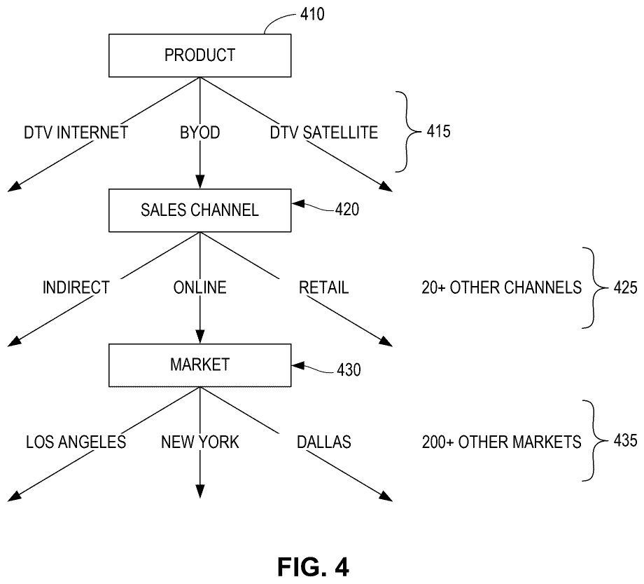

FIG. 3 is a flowchart representative of example machine readable instructions and/or example operations 300 that may be executed, instantiated, and/or performed by programmable circuitry to detect a trend in time-series data. In examples disclosed herein, time-series data may include any number of attributes (e.g., properties, facets, etc.), each having varying values. Different types of time-series data may have different attributes depending on the purpose of the time-series data. For example, the time-series data related to digital television sales may include attributes such as product, sales channel, and market. An example arrangement of such attributes is described in further detail below in connection with FIG. 4. The example machine-readable instructions and/or the example operations 300 of FIG. 3 begin at block 305, at which the trend detection circuitry 120 identifies a first attribute to be analyzed. (Block 305). In examples disclosed herein, the first attribute may be any attribute of the data. Typically, this attribute will be an attribute that has a meaningful distinction to a user who would later review the data and/or predicted trends. For example, a first attribute to be analyzed may be a product attribute. Alternative approaches to selecting the first attribute may additionally or alternatively be used including, for example, selecting based on the number of unique values for a given attribute. In the illustrated example of FIG. 3, a single attribute is chosen, however the example process of FIG. 3 may be repeated for each attribute, to enable identifications of different trends across different combinations of attributes within the data.

The example trend detection circuitry 120 segments the data by value, for the identified attribute. (Block 310). For example, within a product attribute, there may be three separate values including “DTV Internet”, “BYOD”, and “DTV Satellite”. Any number of segments may be created. For example, while in the illustrated example of FIG. 4, three unique values for the product attribute are identified, additional products might also exist and be represented by separate values. In some examples, the values might be represented by numeric values. In such an example, instead of segmenting based on unique values, various segments (e.g., buckets, bins, etc.) may be created that represent ranges and/or collections of values.

The example trend detection circuitry 120 analyzes the segmented data to determine if a trend is present. (Block 320). In this manner, a trend score is created for each of the segmented portions of data. In these examples, the segmented time-series data may be represented as a multivariate time series, representing multiple values (e.g., values of records in the data store 115). One or more techniques for creating a trend score based on the segmented time-series data may be used. For example, multivariate decomposition techniques such as vector autoregressive (VAR) models, multivariate seasonal decomposition (MSTL), or tensor decomposition approaches may be used. In some examples, various machine learning approaches might be used to detect and/or identify trends in the multivariate time-series data including, for example, long short-term memory (LSTM) networks, attention-based models (e.g., transformers such as the large language model (LLM) 140), etc. Other techniques might also be used for identifying a trend score.

The example trend detection circuitry 120 determines whether a trend is present. (Block 330). A trend is detected based on a corresponding trend score exceeding a trend score threshold. In some examples, the trend threshold may be based on the number of attributes and/or sub-attributes under consideration. If no trend is present (Block 330 returns a result of NO), the example trend detection circuitry 120 determines whether any additional attributes of the value selected for analysis exist for analysis. (Block 370). In this manner, the example trend detection circuitry 120 may implement one or more decision-tree logic structures to navigate through the multi-dimensional data set. If additional values exist for analysis (Block 370 returns a result of YES), control returns to block 310 where a subsequent segment corresponding to the additional value, is analyzed.

Returning to block 330, if a trend is identified (Block 330 returns a result of YES), the example trend detection circuitry 120 records an identification of the trend and the identified trend score. (Block 340). This information may be recorded in the data store 115. The example data aggregation circuitry 110 determines whether any sub-attributes exist within the segmented data. (Block 350). As illustrated in FIG. 4, the “sales channel” attribute might be used for further segmentation and detection of a trend. If no sub-attributes exist (Block 350 returns a result of NO), control proceeds to block 370, where the trend detection circuitry 120 determines whether any additional values of the first identified attribute exist for analysis.

Returning to block 350, if sub-attributes exist for identification (block 350 returns a result of YES), the example trend detection circuitry 120 identifies a sub-attribute within the segment. (Block 360). In some examples, analysis is performed to identify the number of distinct values within the potential sub-attribute, and the sub-attribute having the lowest number of distinct values may be selected for subsequent analysis. Of course, further attributes (e.g., the “market” attribute of FIG. 4) might be selected in subsequent iterations of block 360. The example process then proceeds to block 310, where the data is segmented further by values of the sub-attribute. (Block 310).

Control proceeds until no additional trends remain for identification at the varying levels of attributes/sub-attributes. (e.g., until block 370 returns a result of NO). When no additional values of identified attributes (and/or sub-attributes) exist for analysis, the example trend detection circuitry 120 returns the recorded identifications of the trends. (Block 375). In some examples, the trends are sorted by their trend scores and only a top number of trends are returned (e.g., a top ten trends). The example process 300 of FIG. 3 then terminates, and control is returned to block 230 of FIG. 2.

FIG. 4 is a block diagram illustrating an example arrangement of attributes. In the illustrated example of FIG. 4 an item of data may have a first attribute 410, a second attribute 420, and a third attribute 430. Each attribute may have any member of values. For example, the first attribute 410 (e.g., a product attribute) may have three possible values 415 representing three different products. Of course, any number of values might be used for the first attribute. The second attribute 420 (e.g., a sales channel attribute) may include any number of possible values 425 including, for example, indirect channels, online channels, retail channels, etc. In the illustrated example of FIG. 4, twenty or more other possible values may additionally be represented. The third attribute 430 (e.g., a market attribute) might have a value representing a market 435 including, for example, a Los Angeles market, a New York market, a Dallas market, etc. In the illustrated example of FIG. 4, two hundred or more other markets may additionally or alternatively be represented. In the illustrated example of FIG. 4 the attributes 410, 420, 430 are shown in descending order of number of possible values. That is, the number of possible values increases from the first attribute to the second attribute to the third attribute. Of course, any other logical arrangement of the attributes may additionally or alternatively be used. Moreover, in practice, other numbers of attributes might be used (e.g., a fourth attribute, a fifth attribute, etc.)

FIG. 5 is a block diagram illustrating an example prompt 510 requesting trend summarization, and an example output of such a trend summarization 550. The example prompt 510 is provided to the LLM 140 at the request of the trend summarization circuitry 130. In the illustrated example of FIG. 5, the example prompt 510 includes an instruction section 520, an example output section 530, and an example data section 540. The example instruction section 520 provides instructions and/or context to the LLM 1404 processing remainder of the prompt 510. The example output section 530 provides, to the LLM, an example format in which the output of the LLM is expected. The example data section 540 provides data (e.g., detected trend information) to the LLM 140 for summarization. In the illustrated example of FIG. 5, the example data section 540 is represented using a pipe delimited format. However, any other format may additionally or alternatively be used. In some examples, the example data section 540 is omitted from the prompt itself, and provided via, for example, an embedding. In the illustrated example of FIG. 5, the example data section 540 includes three rows of data. However, any number of rows (e.g., records) may be included in the example data section 540.

The example output 550 includes three output sections 551, 552, 553 corresponding respectively to each of the input rows of the example data section. In the illustrated example of FIG. 5, the output sections are presented in a text format, according to the example output section 530 provided by the prompt 510. However, any other type of output format may be specified by the prompt 510 and/or produced via the output 550. For example, the output may be provided using a specified output syntax such as, extensible markup language(XML), JavaScript object notation (JSON), comma separated values (CSV), etc.

FIG. 6 is a block diagram of an example programmable circuitry platform 600 structured to execute and/or instantiate the example machine-readable instructions and/or the example operations of FIGS. 2 and/or 3 to implement the trend explanation system 100 of FIG. 1. The programmable circuitry platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the example data aggregation circuitry 110, the example trend detection circuitry 120, the example trend summarization circuitry 130, the example LLM interface circuitry 135, the example contextualization circuitry 150, the example knowledge obtainer circuitry 160, and the example trend reporter circuitry 170.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIGS. 2 and/or 3, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowcharts of FIGS. 2 and/or 3 to effectively instantiate the circuitry of FIG. 1 as logic circuits to perform operations corresponding to those machine readable instructions. In some such examples, the circuitry of FIG. 1 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 2 and/or 3.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1(L1 ) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine readable instructions represented by the flowchart(s) of FIGS. 2 and/or 3 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 2 and/or 3. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 2 and/or 3. As such, the FPGA circuitry 800 may be configured and/or structured to effectively instantiate some or all of the operations/functions corresponding to the machine readable instructions of the flowchart(s) of FIGS. 2 and/or 3 as dedicated logic circuits to perform the operations/functions corresponding to those software instructions in a dedicated manner analogous to an ASIC. Therefore, the FPGA circuitry 800 may perform the operations/functions corresponding to the some or all of the machine readable instructions of FIGS. 2 and/or 3 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain a binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine readable instructions of FIGS. 2 and/or 3 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 may execute a first portion of the machine readable instructions represented by the flowchart(s) of FIGS. 2 and/or 3 to perform first operation(s)/function(s), the FPGA circuitry 800 of FIG. 8 may be configured and/or structured to perform second operation(s)/function(s) corresponding to a second portion of the machine readable instructions represented by the flowcharts of FIGS. 2 and/or 3, and/or an ASIC may be configured and/or structured to perform third operation(s)/function(s) corresponding to a third portion of the machine readable instructions represented by the flowcharts of FIGS. 2 and/or 3.

It should be understood that some or all of the circuitry of FIG. 1 may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 700 of FIG. 7 may execute machine readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of FIG. 1 may be implemented within one or more virtual machines and/or containers executing on the microprocessor 700 of FIG. 7.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

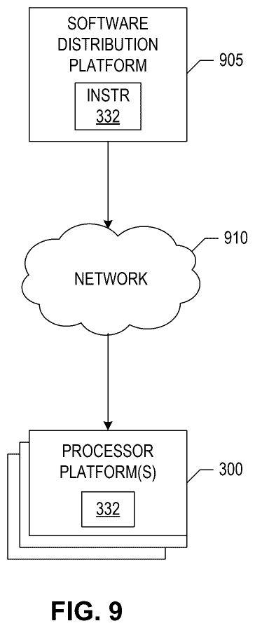

A block diagram illustrating an example software distribution platform 905 to distribute software such as the example machine readable instructions 632 of FIG. 6 to other hardware devices (e.g., hardware devices owned and/or operated by third parties from the owner and/or operator of the software distribution platform) is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions of FIGS. 2 and/or 3, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions of FIGS. 2 and/or 3, may be downloaded to the example programmable circuitry platform 600, which is to execute the machine readable instructions 632 to implement the trend explanation system 100. In some examples, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of referencing a semiconductor device (e.g., a transistor), a semiconductor die containing a semiconductor device, and/or an integrated circuit (IC) package containing a semiconductor die during fabrication or manufacturing, “above” is not with reference to Earth, but instead is with reference to an underlying substrate on which relevant components are fabricated, assembled, mounted, supported, or otherwise provided. Thus, as used herein and unless otherwise stated or implied from the context, a first component within a semiconductor die (e.g., a transistor or other semiconductor device) is “above” a second component within the semiconductor die when the first component is farther away from a substrate (e.g., a semiconductor wafer) during fabrication/manufacturing than the second component on which the two components are fabricated or otherwise provided. Similarly, unless otherwise stated or implied from the context, a first component within an IC package (e.g., a semiconductor die) is “above” a second component within the IC package during fabrication when the first component is farther away from a printed circuit board (PCB) to which the IC package is to be mounted or attached. It is to be understood that semiconductor devices are often used in orientation different than their orientation during fabrication. Thus, when referring to a semiconductor device (e.g., a transistor), a semiconductor die containing a semiconductor device, and/or an integrated circuit (IC) package containing a semiconductor die during use, the definition of “above” in the preceding paragraph (i.e., the term “above” describes the relationship of two parts relative to Earth) will likely govern based on the usage context.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable detection of, explanation of, and contextualization of trends in multi-variate time-series data. Disclosed systems, apparatus, articles of manufacture, and methods improve the efficiency of using a computing device by enabling trend detection reports to be created more expeditiously than can be performed by a human. For example, while humans struggle to keep up with weekly demands for trend summarization, using the techniques disclosed herein enables a computing device to prepare such reports in a timely manner. Disclosed systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. At least one non-transitory machine-readable medium comprising machine-readable instructions to cause at least one processor circuit to at least:
detect a trend in multi-dimensional time-series data;
provide data associated with the detected trend to a first machine learning model to cause summarization of the detected trend; and
provide the summarization of the detected trend to a second machine learning model to cause preparation of an explanation of the summarization, the explanation of the summarization based on one or more documents made available to the second machine learning model.

2. The at least one non-transitory computer readable medium of claim 1, wherein to provide the data associated with the detected trend to the first machine learning model, the machine-readable instructions are to cause one or more of the at least one processor circuit to prepare a first prompt to be provided to the first machine learning model.

3. The at least one non-transitory computer readable medium of claim 2, wherein to provide the summarization of the detected trend to the second machine learning model, the machine-readable instructions are to cause one or more of the at least one processor circuit to prepare a second prompt to be provided to the second machine learning model.

4. The at least one non-transitory computer readable medium of claim 1, wherein the one or more documents are made available to the second machine learning model using retrieval augmented generation.

5. The at least one non-transitory computer readable medium of claim 1, wherein to detect the trend, one or more of the at least one processor circuit is to utilize one or more decision trees.

6. The at least one non-transitory computer readable medium of claim 5, wherein the utilization of the one or more decision trees is based on a plurality of dimensions used when building the decision tree.

7. The at least one non-transitory computer readable medium of claim 6, wherein the one or more decision trees includes a first decision tree and a second decision tree, the first decision tree utilizing the plurality of dimensions arranged in a first order, and the second decision tree utilizing the plurality of dimensions arranged in a second order different from the first order.

8. An apparatus comprising:
interface circuitry;
machine-readable instructions; and
at least one processor circuit to be programmed by the machine-readable instructions to:
detect a trend in multi-dimensional time-series data;
provide data associated with the detected trend to a first machine learning model to cause summarization of the detected trend; and
provide the summarization of the detected trend to a second machine learning model to cause preparation of an explanation of the summarization, the explanation of the summarization based on one or more documents made available to the second machine learning model.

9. The apparatus of claim 8, wherein to provide the data associated with the detected trend to the first machine learning model, one or more of the at least one processor circuit is to prepare a first prompt to be provided to the first machine learning model.

10. The apparatus of claim 9, wherein to provide the summarization of the detected trend to the second machine learning model, one or more of the at least one processor circuit is to prepare a second prompt to be provided to the second machine learning model.

11. The apparatus of claim 8, wherein the one or more documents are made available to the second machine learning model using retrieval augmented generation.

12. The apparatus of claim 8, wherein to detect the trend, one or more of the at least one processor circuit is to utilize one or more decision trees that are based on a plurality of dimensions used when building the decision tree.

13. The apparatus of claim 12, wherein the one or more decision trees includes a first decision tree and a second decision tree, the first decision tree utilizing the plurality of dimensions arranged in a first order, and the second decision tree utilizing the plurality of dimensions arranged in a second order different from the first order.

14. A method comprising:
detecting a trend in multi-variate time-series data;
providing data associated with the detected trend to a first machine learning model to cause summarization of the detected trend; and
providing the summarization of the detected trend to a second machine learning model to cause preparation of an explanation of the summarization, the explanation of the summarization based on one or more documents made available to the second machine learning model.

15. The method of claim 14, wherein to provide the data associated with the detected trend to the first machine learning model, the method further includes preparing a first prompt to be provided to the first machine learning model.

16. The method of claim 15, wherein to provide the summarization of the detected trend to the second machine learning model, the method further includes preparing a second prompt to be provided to the second machine learning model.

17. The method of claim 14, wherein the one or more documents are made available to the second machine learning model using retrieval augmented generation.

18. The method of claim 14, wherein the trend is detected using one or more decision trees.

19. The method of claim 18, wherein the use of the one or more decision trees is based on a plurality of dimensions used when building the decision tree.

20. The method of claim 19, wherein the one or more decision trees includes a first decision tree and a second decision tree, the first decision tree utilizing the plurality of dimensions arranged in a first order, and the second decision tree utilizing the plurality of dimensions arranged in a second order different from the first order.
